(19) United States
(12) Patent Application Publication
(10) Pub. No.: US 2005/0150824 A1
(43) Pub. Date: Jul. 14, 2005

(54) Water filtration tank dispensing system

(75) Inventors: Walter Birdsell, Marlborough, MA (US); Brian J. Matt, Wellesley, MA (US)

Correspondence Address: DARBY & DARBY P.C., P. O. BOX 5257, NEW YORK, NY, 10150-5257, US

(73) Assignee: Kaz, Incorporated, New York, NY (US)

(21) Appl. No.: 10/755,091

(22) Filed: Jan. 8, 2004

(51) Int. Cl. B01D 27/08

(52) U.S. Cl. 210/244; 210/123; 210/149; 210/175; 210/482

(57) ABSTRACT

A water filtration tank dispensing system comprised of a fill tank and a cabinet body. Disposed within the cabinet is at least one of a cooling chamber and a heating chamber and at least one tap disposed on the cabinet body. The filtration tank is mounted on the top of the cabinet body and comprises a fill tank, a filter holder tray, and a removable reservoir. The filter holder is fluidically connected between the fill tank and the removable reservoir The removable reservoir is disposed within the cabinet top and fluidically connected to the cooling and heating chambers. The fill tank is water tight and comprises a cap assembly containing a valve located on the bottom. In a preferred embodiment, the fill tank is an ultrasonic welded tank. The fill tank is removable from the filtration system for refilling at a location remote from the dispensing unit.

### FIELD OF INVENTION

The present invention generally relates to tank systems comprising filters for filtration of the water contained therein, along with dispensing units for connecting with the tank system. More specifically, the present invention relates to water filtration tank dispensing systems where at least some portion of the tank system is removable, and refillable, at a location remote from the dispensing unit.

### BACKGROUND OF THE INVENTION

Bottled-water dispensers are found in homes, offices and other locations where pure drinking water is desired. Typically, bottled-water dispensers include a cooling and heating unit, with an interchangeable glass or plastic water-filled bottle mounted in an inverted position on the top of the dispensing unit. Pure drinking water is available from commercial vendors and supplied in the interchangeable bottle. The water is dispensed through a manually operated tap on the dispensing unit. When the water in the bottle is completely dispensed, the empty bottle is replaced with a filled bottled by removing the empty bottle and inverting the filled replacement bottle onto the top of the dispensing unit.

Changing the bottles can be particularly difficult for small persons or persons of limited strength. Further, quickly inverting a heavy, filled bottle without spilling quantities of water is a challenge and a disadvantage of conventional bottled-water dispensers. Therefore, the bottles of conventional water dispensers cannot be changed without risk of wetting the areas around the dispensers or the persons changing the bottles. Also, conventional bottled-water dispensers cannot be placed in a location where water spillage could cause damage. Conventional water dispensers, therefore, can be messy and wasteful.

Bottle-less water dispensers overcome some of the disadvantages of conventional bottled-water dispensers. In bottle-less water dispensers, water is continuously pumped or otherwise supplied from a pure water source into a cooling-dispensing unit similar to the cooling-dispensing unit of a conventional bottled-water dispenser. Because the water is pumped from a continuous source and a bottle is not needed, bottle-less water dispensers, as their name implies, do not employ bottles to store the pure water.

Bottle-less water dispensers are less psychologically attractive to the public than bottled-water dispensers. The public associates the quality of water dispensed by a conventional bottled-water dispenser with the pure, crystal-clear look of the water in the bottle above the dispensing unit. The pure, crystal-clear appearance of the water in the bottle reminds the user that the dispenser only dispenses pure water. A water dispenser without a bottle displaying pure water, however, appears to dispense little more than tap water and does not provide the psychological assurance provided by conventional bottled-water dispensers that pure water, rather than tap water, is being dispensed. Therefore, bottle-less water dispensers are less popular with the public than bottled-water dispensers. Also, bottle-less dispensers require plumbing connections and can only be used in locations where a water supply is available.

In particular, there is a need for a water filtration tank dispensing system which is easy to refill, while also supplying pure, crystal-clear water that can be viewed by users. The present invention satisfies these and other needs, as set forth in the following description.

### SUMMARY OF THE INVENTION

In accordance with one aspect of the invention, a water filtration tank dispensing system comprises a cabinet body with either or both a cooling chamber and a heating chamber disposed within the cabinet body, and at least one tap disposed on the cabinet body. A filtration tank is mounted on top of the cabinet body and comprises a watertight fill tank portion, a filter holder tray, and a removable reservoir. The filter holder tray is fluidically connected between the fill tank and the removable reservoir. The removable reservoir is disposed in the cabinet top and fluidically connected to the cooling and heating chambers. Preferably, the watertight fill tank is an ultrasonically welded tank which is removable and refillable at a location remote from the cabinet.

These and other aspects, features, and advantages can be further appreciated from the accompanying drawing Figures and description of certain illustrative embodiments.

### BRIEF DESCRIPTION OF THE DRAWING FIGURES

FIG. 1 is a perspective view of an embodiment of the present invention;

FIG. 2 is an exploded cutaway view of the embodiment depicted in FIG. 1;

FIG. 3 is a perspective view of the filtration tank of the embodiment depicted in FIG. 1;

FIG. 4 is an exploded perspective view of the filtration tank depicted in FIG. 1;

FIG. 5 is a partial sectional view taken along line 5-5 of FIG. 1;

FIG. 6 is an exploded cutaway view of an alternative embodiment of the invention; and

FIG. 7 is an exploded perspective view of an alternative embodiment of the invention.

### DETAILED DESCRIPTION OF THE ILLUSTRATIVE EMBODIMENTS

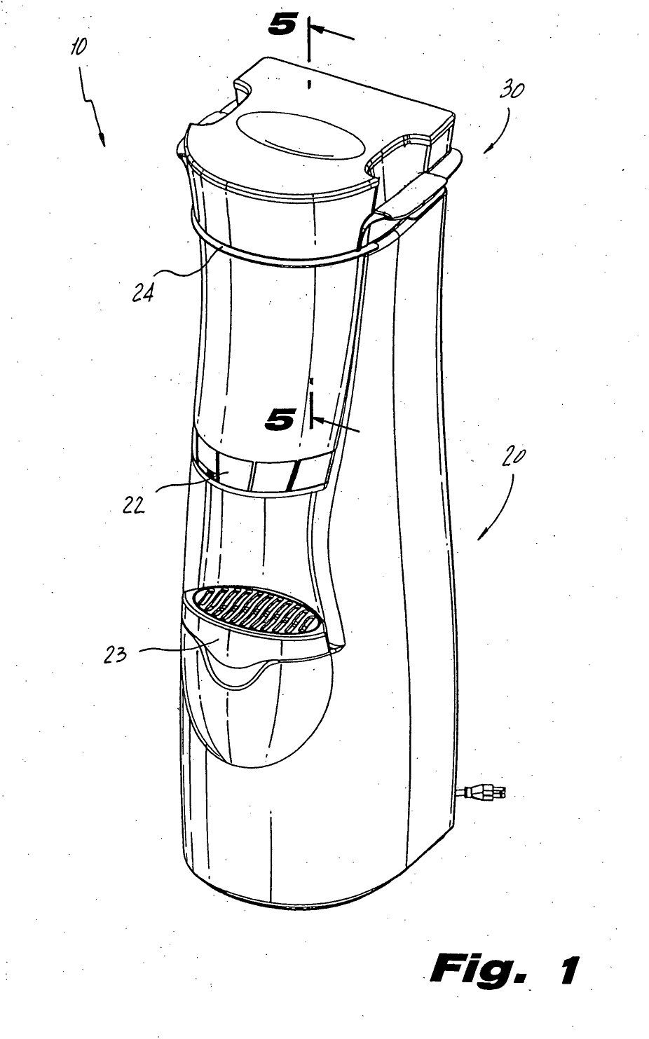

FIGS. 1-5 illustrate an embodiment of a water filtration tank dispensing system 10 in accordance with the invention. The tank dispensing system is comprised of a cabinet body 20 and a water filtration tank 30. Disposed within the tank is at least one chamber for storing water. Preferably, the chamber within the cabinet body is either or both a cooling chamber and a heating chamber, for controlling the temperature of the water.

A tap 22, disposed on an outer surface of the cabinet body, is in fluid communication with the chamber(s) within the cabinet. Also disposed on the outer surface of the cabinet is a spill reservoir 23. The spill reservoir is positioned below the tap in a manner to permit overflow and spillage from the tap to fall into the spill reservoir 23. At the top of the cabinet body the outer surfaces of the cabinet body are truncated to form an aperture 24. The aperture is shaped and sized to accommodate the lower portion of the water filtration tank 30.

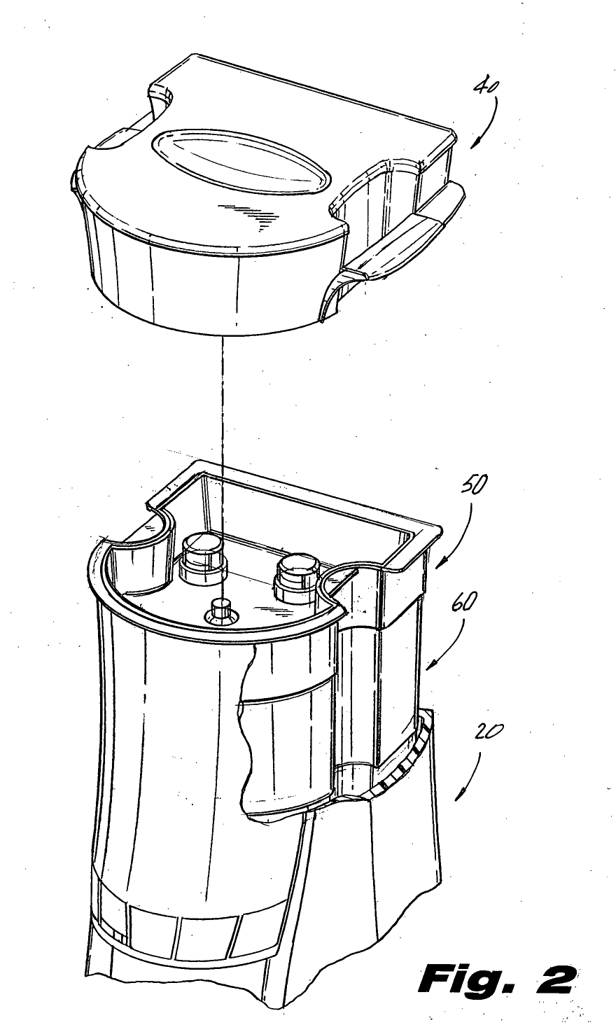

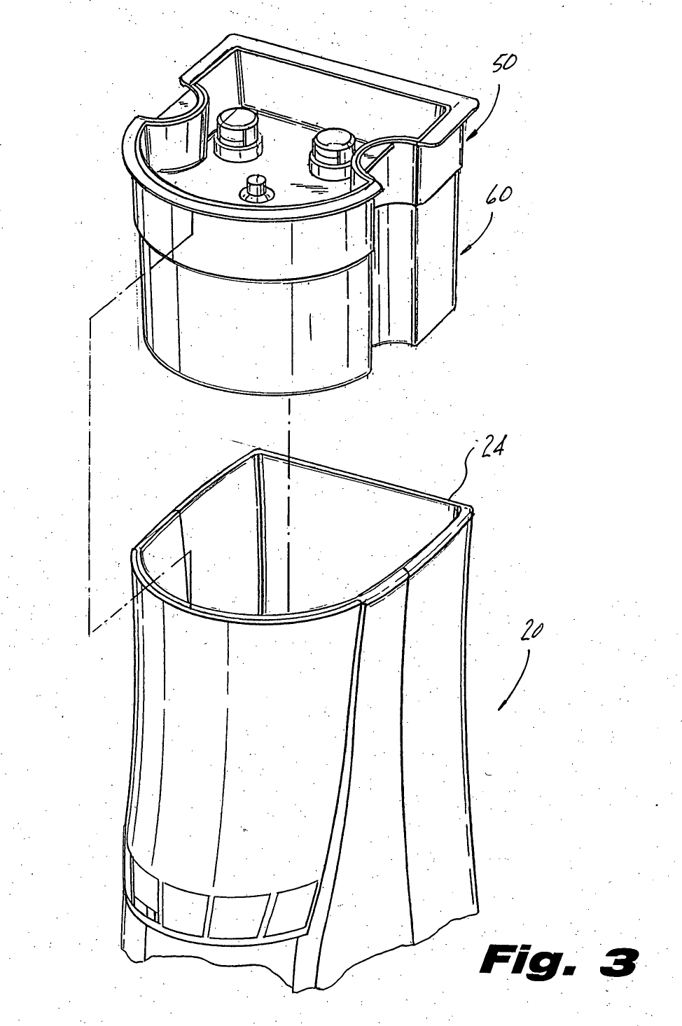

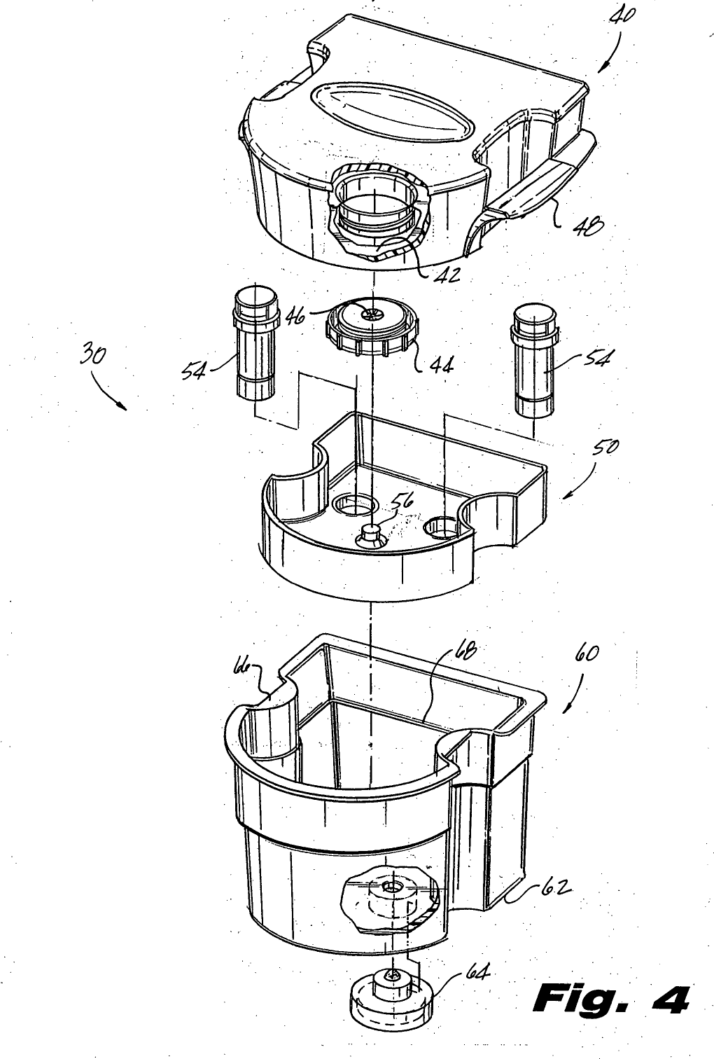

FIGS. 2 and 3 illustrate an embodiment of the invention and depict the interconnection of the invention components. FIG. 2 depicts fill tank 40 separate and removed from the water filtration tank 30 and the water dispenser cabinet 20. Fill tank 40 is removable and refillable at a location remote from the cabinet 20. FIG. 3 depicts the other components of the water filtration tank 30, filter tray holder 40 and removable reservoir 60, removed from the cabinet 20. The filter tray 40 is further separable from the reservoir 60, as is shown in FIG. 4.

As depicted in FIG. 4, the water filtration tank 30 includes a fill tank portion 40, a filter holder tray 50, and a removable reservoir 60. The filter holder tray 50 is positioned between, and is in fluid communication with, the fill tank and the removable reservoir.

The fill tank 40 is formed to have a top, a plurality of separate side pieces, and a bottom 42. In an alternative configuration, a unitary, formed tubular body can be substituted for the separate side pieces. The fill tank is a watertight unit, preferably joined by ultrasonic welding. However, the invention is not so limited to a single construction technique. Other methods for creating a watertight unit known to persons of skill in the art are suitable for the invention. The fill tank bottom 42 includes a cap assembly 44 and a valve 46. The valve 46 is self-closing, for instance, of the spring-loaded variety.

In operation a user removes the fill tank portion 40 from the filtration tank dispensing system 10 and transports the fill tank 40 to a location for filling with water, which may be remote from the dispensing system 10. In alternative embodiments the fill tank portion 40 includes protruding hand grips 48 or recessed hand holds (not shown) to aid the user in transporting the fill tank between the dispensing system 10 and the remote source of water. Removal of the fill tank from the dispensing system 10 causes valve 46 to close. The closing of valve 46 prevents spillage from the fill tank 40 during removal, transportation, and installation.

The filter holder tray 50 includes at least one cartridge filter holder 54, and an upward protrusion 56 extending from the bottom of the filter tray and ending in a generally horizontal, flat surface portion. Placement of the fill tank 40 onto the tank dispensing system 10 seats the valve 46 on the flat portion, causing the valve to open. Water will then flow from the fill tank 40 into the filter holder tray 50 and through the cartridge filter holder 54. The water will then be collected in the removable reservoir 60.

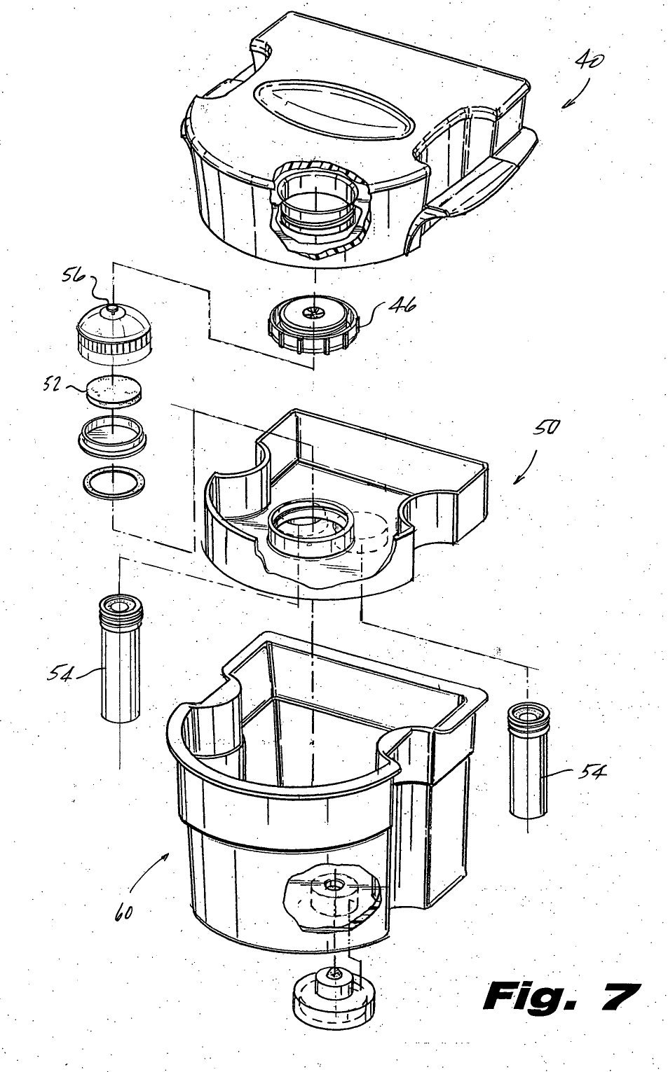

FIG. 7 illustrates an alternative embodiment for filter holder tray 50. In this configuration filter holder tray 50 includes an upward protrusion 56 which contains a plurality of slots and or apertures along its sides. Disposed within the protrusion 56 is a disk filter 52 and sealing gaskets. The disk filter 52 can be a replaceable disk filter. The cartridge filter 54 is mounted under the bottom of the filter holder tray 50 and is in fluid communication with the underside of disk filter 52. The plurality of apertures in protrusion 56 allow fluid contained in the filter holder tray to gravity feed through the disk filter, through channels, and then into the cartridge filter.

Referring again to FIG. 4, the gravity-fed water from the filter holder tray 50 collects in the removable reservoir 60. This water will pass through the reservoir and into the cooling and heating chambers disposed in the cabinet body 20. The underside 62 of the reservoir is shaped and sized to snugly fit within the cabinet body aperture 24. A float valve 64 is disposed at the bottom of the removable reservoir. When the chambers disposed within the cabinet body are full, a float cap within the float valve 64 will stop the flow of water into the chambers. As a user dispenses water from the water filtration tank dispensing system 10, the water level within the chambers will drop and the float valve 64 will open to allow the flow of water to continue into the cabinet body, until it is stopped again upon reaching a predetermined level.

The removable reservoir further comprises a lift-out grip 66 integrated around the circumference of its body. The filter holder tray 50 is placed within the reservoir 60 and rests on an inwardly protruding ledge 68. The form of the filter tray 50 interlocks with the form of the reservoir to create a watertight fit.

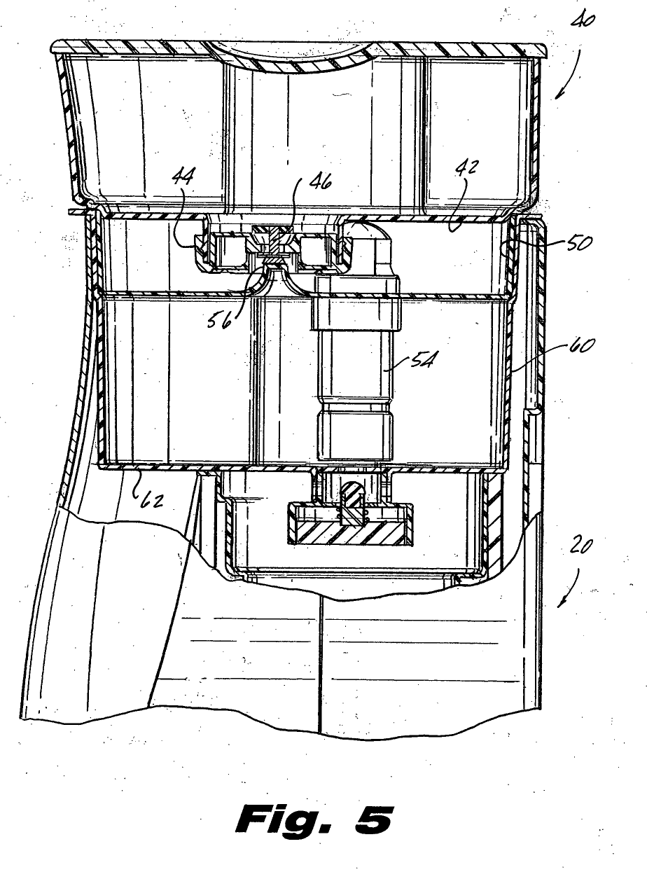

FIG. 5 is a cross section of an illustrated embodiment taken along view line 5-5 of FIG. 1. The fill tank 40 is shown resting upon the filter holder tray 50, which itself is nested into the removable reservoir 60. Self-closing valve 46 is shown pressed against rib 56 causing the valve 46 to be held in the open position. Float valve 64 is located at the base of the removable reservoir and is dependent on the dispenser water level for positioning between open and closed.

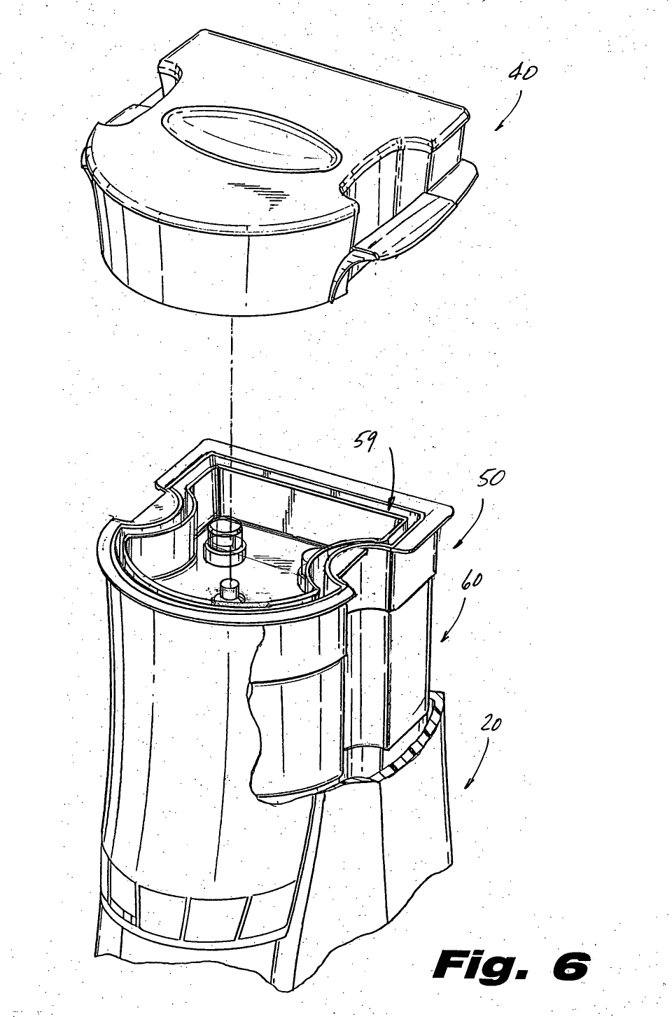

FIG. 6 depicts an alternative embodiment of the invention. A moat 59 is formed along an upper rim of the vertical sides of filter holder tray 50. The moat 59 is designed to interlock with a corresponding portion of fill tank bottom 42 to form a watertight barrier. The moat is operable to prevent water leaking from between the filter holder tray 50 and the removable reservoir 60.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

1. A water filtration tank dispensing system comprising:
a cabinet body having a top;
at least one of a cooling chamber and a heating chamber disposed within the cabinet body;
at least one tap disposed on the cabinet body;
the tap being fluidically connected to said at least one of the cooling chamber and the heating chamber for dispensing the water;
a filtration tank mounted on the top of the cabinet body;
the filtration tank comprising:
a removable fill tank having a valve disposed on a bottom thereof;
a filter holder tray; and
a removable reservoir;
the filter holder tray being fluidically connected between the fill tank and the removable reservoir; and
the removable reservoir being disposed in the cabinet top and fluidically connected to said at least one of the cooling chamber and the heating chamber.

2. The water filtration tank dispensing system of claim 1, wherein the fill tank is an ultrasonic welded tank.

3. The water filtration tank dispensing system of claim 1, wherein the fill tank comprises a plurality of separate side pieces.

4. The water filtration tank dispensing system of claim 1, wherein the fill tank comprises a tubular body.

5. The water filtration tank dispensing system of claim 1, wherein the removable reservoir comprises a float valve disposed within the fluidical connection to said at least one of the cooling chamber and the heating chamber.

6. The water filtration tank dispensing system of claim 1, wherein the filter holder tray comprises at least one filter cartridge disposed within the fluidical connection to the removable reservoir.

7. The water filtration tank dispensing system of claim 1, wherein the filter holder tray comprises a disk filter and at least one cartridge filter, wherein the disk filter is disposed within the fluidical connection to the fill tank and the at least one filter cartridge is disposed between the disk filter and the fluidical connection to the removable reservoir.

8. A water filtration tank dispensing system comprising:
a cabinet body having a top;
at least one water temperature controlling chamber means disposed within the cabinet body;
at least one water dispensing means disposed on the cabinet body;
the water dispensing means fluidically connected to said at least one water temperature controlling chamber means; and
a tank means removably mounted on the top of the cabinet body;
the tank means comprising:
a watertight removable fill tank, a filter holder assembly,
and a removable reservoir; and
the tank means fluidically connected to said at least one water temperature controlling chamber means.

9. A filtration tank system comprising:
a fill tank;
a filter holder tray; and
a removable reservoir;
the filter holder tray being fluidically connected between the fill tank and the removable reservoir; and
wherein the fill tank comprises a cap assembly disposed in a bottom of the tank.

10. The filtration tank system of claim 9, wherein the fill tank is an ultrasonically welded watertight container comprising a plurality of separate side pieces.

11. The filtration tank system of claim 9, wherein the fill tank is an ultrasonically welded watertight container comprising a tubular body.

12. The filtration tank system of claim 9, further comprising:
a self-closing valve disposed in the cap assembly;
a float valve disposed in a bottom of the removable reservoir; and
wherein the fill tank is separable and removable from the filter holder tray.
